(19) United States
(12) Patent Application Publication
(10) Pub. No.: US 2024/0286076 A1
(43) Pub. Date: Aug. 29, 2024

(54) METHOD AND SYSTEM FOR SULFUR, CARBON DIOXIDE AND HYDROGEN RECOVERY

(71) Applicant: Abu Dhabi National Oil Company, Abu Dhabi (AE)

(72) Inventors: Zaher SALEM, Abu Dhabi (AE); Abdullah MALEK, Abu Dhabi (AE); Fahad AL-SADOON, Abu Dhabi (AE); Marwan Khamis HAGGAG, Abu Dhabi (AE); Iman USTADI, Abu Dhabi (AE)

(73) Assignee: Abu Dhabi National Oil Company, Abu Dhabi (AE)

(21) Appl. No.: 18/562,454

(22) PCT Filed: Oct. 17, 2022
(86) PCT No.: PCT/IB2022/059933

§ 371 Date: Nov. 20, 2023

(51) Int. Cl. B01D 53/75; B01D 19/00; B01D 53/00; B01D 53/047; B01D 53/26; B01D 53/28; B01D 53/30; B01D 53/48; B01D 53/73; B01D 53/76; C01B 17/16

(52) U.S. Cl. CPC B01D 53/75; B01D 19/0005; B01D 53/002; B01D 53/047; B01D 53/263; B01D 53/28; B01D 53/30; B01D 53/48; B01D 53/73; B01D 53/76; C01B 17/162; B01D 2256/16; B01D 2256/22; B01D 2257/108; B01D 2257/30; B01D 2257/504; B01D 2257/80

(57) ABSTRACT

The present invention relates to a method for sulfur (S), carbon dioxide (CO2) and hydrogen (H2) recovery from a gaseous stream, the method comprising: providing a first gaseous entry stream and optionally a second gaseous entry stream, both comprising hydrogen sulfide (H2S) and CO2; a sulfur recovery step for recovering sulfur (S) from at least part of the H2S provided with the gaseous entry stream/s) to produce a liquid phase comprising sulfur (S); a CO2 recovery step for recovering at least part of the CO2 provided with the gaseous outlet stream; and an H2 recovery step (10) for recovering at least part of the H2 provided with the gaseous outlet stream.

### 1. TECHNICAL FIELD

The present invention relates to a method for sulfur (S), carbon dioxide (CO2) and hydrogen (H2) recovery from a gaseous stream. The gaseous stream comprises acid gases, which may be provided from a natural gas feed stream after an acid gas removal treatment. In particular, the present invention relates to method for improved sulfur (S), CO2 and H2 recovery and to reduce emissions.

The present invention further relates to a respective system for performing such a method and a computer program for controlling and/or carrying out the method and the system.

### 2. TECHNICAL BACKGROUND

Natural gas produced in gas fields typically consists of a mixture of hydrocarbons, hydrogen sulfides (H2S, also referred to as an acid gas) carbon dioxide (CO2, also referred to as an acid gas) and organic sulfur species, such as carbonyl sulfide (COS), carbon disulfide (CS2). The amount of the sulfur compounds may range from about 0.1 vol % to about 25 vol %. The amount may depend on field location and well age from which natural gas is produced.

### Acid Gas/Sour Gas

Acid gas is typically removed from natural gas. Acid gas is a gas mixture containing (significant) quantities of hydrogen sulfides (H2S), carbon dioxide (CO2), or similar acid gases. The pH scale may be used to determine whether a gas is acidic or not. The pH ranges from 0 to 14 and a value greater than or equal to 7 is basic while a value below 7 is acidic. The term sour gas means a natural gas or any other gas that contains hydrogen sulfide (H2S) and carbon dioxide (CO2).

### Environmental Concerns

The acid gases such as hydrogen sulfides (H2S) are toxic and have adverse impacts to the environment. When an acid mixture is burned, it produces sulfur oxides (SO), which, when released to the atmosphere, can cause acid rain, which can lead to respiratory health issues, kill plants and wildlife, and contaminate water sources. Acid gases are lethal and also flammable, which makes their occurrences in the atmosphere dangerous. High concentrations of carbon dioxide (CO2), which may also form part of acid gases, can cause visual and hearing dysfunctions. Local restrictions may vary geographically, such that an allowable extent of gases released varies.

Accordingly, the acid gases are usually removed from the natural gas and the removed gas requires adequate treatment to comply with the above noted environmental concerns.

### Acid Gas Removal Unit

Thus, an acid gas removal unit (AGRU) is usually employed in facilities that are processing natural gas to separate these acid gases (e.g. H2S). The AGRU typically also separates CO2, COS, CS2 from the natural gas. Thus, acid gas comprising several species, e.g. H2S, CO2, is retrieved after the AGRU.

### Sulfur Recovery Unit, Incinerator, Tail Gas Treatment Unit

H2S is typically converted into elemental sulfur (S) using a sulfur recovery unit (SRU) and eventually recovered in liquid and/or solid form. Usually, the SRU comprises a Claus unit, wherein H2S is reacted over a catalyst with air to form elemental sulfur and water according to simplified equation 1 below.

$${H}_{2} S + \frac{1}{2} {O}_{2} \to S + {H}_{2} O \qquad ( 1 )$$

An improved Claus unit comprises a first exothermic combustion reaction (equation 2 below), and a moderately exothermic catalytic reaction (equation 3 below).

$${H}_{2} S + 1 \frac{1}{2} {O}_{2} \to {SO}_{2} + {H}_{2} O \qquad ( 2 )$$

$$2 {H}_{2} S + {SO}_{2} \to \frac{3}{n} {S}_{n} + 2 {H}_{2} O$$

The oxygen (O2) in the above equations typically comes from air.

Residual sulfur species contained in gases leaving the SRU may be oxidized, e.g. in an incinerator, and released to the atmosphere as sulfur dioxide (SO2) and H2O. The oxidation in such an incinerator requires a fuel gas, causing substantial CO2 emissions, which severely impacts the environment. SRUs are typically required to remove sulfur compounds (e.g. H2S) such that an overall SRU recovery of more than 99.9% is achieved.

A tail gas treatment unit (TGTU) may be applied to further reduce an amount of sulfur compounds (e.g. SO2, COS and CS2). The TGTU reduces oxidized sulfur compounds back into H2S and CO2, which is fed back to the SRU.

### Demand

Environmental restrictions also require reducing an amount of SO2 and CO2 released to the atmosphere. It is also expected that an increased public environmental awareness will dictate harsher limitations in the nearer future in terms of allowable emissions. This calls for more improved ways to eliminate all emissions associated with processing of natural gas.

Thus, CO2 in the acid gas should be captured (e.g. recovered). Typically, the presence of both acid gases, H2S and CO2, in the natural gas, complicates recovery of CO2. The acid gas has to be converted into sulfur and into a (high purity) CO2 stream with a low H2S content.

Existing CO2 capture technologies in the context of processing natural gas have several deficiencies. As an example, existing CO2 capture technologies apply amine-based solvents, which are expensive as they require operation at a low pressure and at relatively high temperature. Such conditions are unfavorable for the solvent removal efficiency and capacity. Thus, the pick-up rate may be low. Amine-based solvents are also prone to foaming, to operational instability and less resilient to compositional variations of a gaseous stream to be treated. Such technologies also have high operational expenditures (OPEX) and/or capital expenditures (CAPEX) due to heating power required to regenerate the solvent. Furthermore, known technologies provide for SRUs operating with air, causing excessive amounts of N2 in the tail gas, which requires increased sizes of the units. In addition, conventional technologies fail to utilize the potential of H2S as a resource for hydrogen and, thus, fail to provide for capturing H2 to a sufficient extent.

Known technologies also fail to account for CO2 reduction to an adequate extent, for instance in respect of the applied incinerator units. Typically, sulfur degassing units are applied to degas any liquid sulfur formed within the SRU, e.g. to remove H2S from liquid sulfur, with the aid of air. Such removed H2S is oxidized in considerable amounts in the incinerator, causing significant amounts of CO2 to be exhausted to the atmosphere. In addition, such incinerators require additional fuel gas for operation.

In view of the above deficiencies of conventional technologies, it is of utmost importance to provide for more ecological and economical technologies as this paves the way to further reduce emissions when processing natural gas.

Against this background, an object of the present invention is to improve the deficiencies of the prior art and to address one or more or all of the above-mentioned shortcomings of the prior art. It is particularly an object to provide a method and system to reduce emissions resulting from acid gases. Thus, CO2 emissions and emissions resulting from sulfide compounds when processing natural gas comprising acid gases should be reduced. Furthermore, it is an object to provide a method and system for capturing and using CO2 and H2 to reduce emissions. Generally, it is an object of the invention to provide a cost-effective method of processing natural gas and/or acid gas, such that OPEX and/or CAPEX are reduced.

These and other objects, which become apparent from the following description, are solved by the subject-matter of the independent claims.

### 3. SUMMARY OF THE INVENTION

An aspect of the invention relates to a method for sulfur (S), carbon dioxide (CO2) and hydrogen (H2) recovery from a gaseous stream, the method comprising:
providing a first gaseous entry stream and optionally a second gaseous entry stream, both comprising hydrogen sulfide (H2S) and CO2;
a sulfur recovery step for recovering sulfur (S) from at least part of the H2S provided with the gaseous entry stream(s) to produce a liquid phase comprising sulfur (S),
   wherein recovering comprises a reaction of the gaseous entry stream(s) with oxygen enriched air, wherein the oxygen enriched air contains preferably at least 30%, more preferably at least 40%, more preferably at least 50%, more preferably at least 60%, more preferably at least 70%, more preferably at least 80%, more preferably at least 90%, more preferably at least 95%, most preferably at least 98.5% oxygen,
   wherein the sulfur recovery step also produces a gaseous outlet stream comprising CO2 and H2;
a CO2 recovery step for recovering at least part of the CO2 provided with the gaseous outlet stream;
an H2 recovery step for recovering at least part of the H2 provided with the gaseous outlet stream;
an incinerating step for incinerating an off-gas derived from the gaseous outlet stream, wherein at least 50%, preferably at least 55%, more preferably at least 60%, more preferably at least 65%, more preferably at least 70%, more preferably at least 75%, more preferably at least 80%, more preferably at least 85%, more preferably at least 90%, most preferably at least 95% of an energy required for the incinerating is provided by the recovered H2.

The sulfur recovery step comprises oxygen enriched air. This has the advantage that, compared to conventional air, less nitrogen (N2) is present. Thus, the volume of streams may be reduced significantly. In here, the streams may exemplarily comprise the gaseous outlet stream produced in the sulfur recovery step and/or a stream derived therefrom, e.g. a stream downstream of the sulfur recovery step. Accordingly, the overall sizes of the components and/or units used to perform the inventive method can be reduced. This may be beneficial as N2 is an inert gas, and, thereby, may not be necessary.

Reducing the volume of the streams allows for downsizing of the components and/or units, which entails a reduction of the costs and facilitates operation. This may contribute to a reduction of about 62% or more in terms of CO2 emissions. Further, substantially all remaining emissions, e.g. NOx/SOx, are reduced proportionally, which is highly appreciated. Further, the hereby provided reduced sizes of the units and/or components simplify any maintenance operation, as the accessibility is facilitated. Further, any parts necessary to provide an infrastructure to the units and/or components can be manufactured more easily.

A reaction of the first (optionally the second and/or any further) gaseous entry stream with the oxygen enriched air may comprises a thermal and/or catalytic reaction. The gaseous entry stream(s) may also comprise water, for instance in a saturated state, and/or traces of sulfur compounds. The recovered sulfur (S) of the sulfur recovery step may be elemental sulfur. The recovered sulfur (S) comprised by the liquid phase and may, in one example, be formed following a condensing step.

The CO2 recovery step for recovering at least part of the CO2 provided with the gaseous outlet stream provides for a CO2 stream with a high concentration of CO2 (high CO2 purity), which may be useful for, e.g. enhanced gas and/or oil recovery (EOR).

Another advantage attributable to the oxygen enriched air is that a greater extent of H2 can be produced in the sulfur recovery step. This may be caused by increased temperatures and/or an improved conversion reaction within the sulfur recovery step, which promote the formation of H2.

The H2 recovery step is particularly advantageous, as the increased amount of H2 produced in the gaseous outlet stream of the sulfur recovery step makes a H2 recovery more effective and more useful. The recovered H2 may be used as described herein, e.g. to replace traditional fuels and/or the recovered H2 may be applied externally. This promotes a further reduction of CO2 emissions.

As described herein, it may be the case that a dedicated separate H2 recovery step is not performed, but that the H2 recovery step may be comprised by the CO2 recovery step. This may, for instance, be advantageous in case a substantial amount of a gaseous outlet stream (directly) downstream the CO2 recovery step may be incinerated in the incinerating step. It is appreciated that, in such a case, the H2 content of said gaseous outlet stream (directly) downstream the CO2 recovery step is relatively high (e.g. at least about 45% or 48%), thereby it may be used as fuel. Said gaseous outlet steam (directly) downstream the CO2 recovery step may then also be referred to as off-gas. Furthermore, it may be regarded as at least part of the recovered H2 for the energy required for the incinerating.

Providing recovered H2 for the energy required for incinerating has the advantage that emissions are further reduced, for instance by 81% overall. It is appreciated that an amount of external fuel can thus be reduced. External fuel may be understood as fuel provided not from gaseous steam(s) and/or the natural gas from which the gaseous stream herein derive. As an example for an external fuel, methane (CH4) may be mentioned. The heating value of H2 (˜120-142 MJ/kg) may be about 2.4 times higher than the heating value of methane (CH4) (˜50-55 MJ/kg), which is advantageous.

The off-gas that is incinerated downstream the sulfur recovery step may be at least part of the gaseous outlet stream produced in the sulfur recovery step. Typically, the gaseous outlet stream produced in the sulfur recovery step may be processed within and/or downstream the CO2 and/or the H2 recovery step before being incinerated as off-gas. In one example, the off-gas may comprise a substantial amount of the gaseous outlet stream of the sulfur recovery step (this may be the case, if a treatment step and/or a TGTU and/or any component/unit is in a start-up, shut-down and/or upset state and/or during maintenance and/or overhaul).

The off-gas may contain small amounts of H2S, COS and/or CS2. These may also be termed trace components. These components should be incinerated before released (e.g. vented) to the atmosphere. It is appreciated that the amount of the off-gas that incinerated is small, as the amount of N2 is reduced. Another contribution to the reduced off-gas is that some trace components, e.g. COS and/or CS2 will be part of recovered CO2, which is recovered, e.g. removed from a gaseous outlet stream. Thus, a reduction of the amount of fuel required for incinerating is facilitated. It is also appreciated that, by way of removal of the trace components, a further reduction of CO2 emissions (from the incinerator step) may be achieved. In conventional technologies, the incinerating step requires a relatively large incinerator unit to allow the relatively large amount of (inert) N2 contained in the off-gas to pass through. This disadvantage is overcome.

The gaseous stream(s) (e.g. the first, second, third) that is(are) provided according to this method may also comprise water (H2O) and/or hydrocarbons. The gaseous stream(s) may originate from natural gas that has been treated in an acid gas removal unit (AGRU).

The sulfur recovery step may comprise a Claus process and/or a modified Claus process, which is adapted to cope with the oxygen enriched air entering the sulfur recovery step.

The inventors found that the method provides for significant reduction of CO2 emissions, such that more than 81% of CO2 emissions may be reduced. It may also be possible to substantially eliminate CO2 emissions, if recovered H2 is used as fuel. Furthermore, the CO2 capture efficiency may be about 98%, 99% or even higher (e.g. 99.4%). In addition, the recovered H2 can advantageously comply with requirements of blue hydrogen as described herein. It is appreciated that these achievements are in line with rising decarbonization goals that are imposed worldwide. Furthermore, significant savings in OPEX/CAPEX are reached by the inventive method.

Preferably, the method further comprises a degassing step for degassing, using a stripping agent, preferably using no ambient air as the stripping agent, at least part of residual H2S contained in the liquid phase comprising sulfur (S) to form the second gaseous entry stream comprising gaseous H2S and at least part of the stripping agent.

Degassing at least part of residual H2S (and/or H2Sn, as described herein) may be understood in such a way that H2S (and/or H2Sn) is/are removed from the liquid phase and made gaseous. Liquid sulfur may typically be formed in the sulfur recovery step. For instance, a condenser may be applied such that the liquid sulfur is collected (e.g. by gravity) at a bottom of the condensers (e.g. in a pit). The liquid phase comprising sulfur may be in equilibrium with a gas, e.g. with the vapor form of sulfur.

Thereby, a small amount of H2S may be dissolved. It may also be possible that H2Sn is dissolved in the liquid sulfur. Liquid H2S (and/or H2Sn), if not degassed, may be detrimental due to the release of flammable, toxic and/or corrosive H2S. Thus, degassing is beneficial.

Preferably substantially no air should be used as a stripping agent. This reduces the amount of N2 and facilitates that the formed gas comprising H2S (i.e. the second gaseous entry stream) can be circulated to the SRU. Thus, in one example, the sulfur recovery could be enhanced without necessitating increasing sizes of the components and/or parts.

In one example, air may have the advantage that it comprises O2 which enhances degassing with an oxidation reaction (e.g. H2Sn+O2→SO2+H2O and H2Sn+O2→S+H2O). However, the disadvantages of air, as described herein, outweigh this advantage. Thus, using air may not be advantageous in reducing emissions.

Preferably, at least part of the recovered CO2 is used as the stripping agent (15), preferably wherein at least 90%, preferably at least 94%, more preferably at least 96%, most preferably 100% of the recovered CO2 are used as the stripping agent.

Using CO2 as a stripping agent is advantageous compared to air, as CO2 is a better physical stripping agent. Using CO2 as the stripping agent, preferably using CO2 substantially as the sole stripping agent, allows to circulate the formed gas after the degassing step to the sulfur recovering step as the third gaseous entry stream, as there is substantially no N2 in the gas compared to using air. In one example, the CO2 used as stripping agent is external CO2. Preferably, the CO2 used as stripping agent is recovery CO2 as described herein.

If air is used as the stripping agent, the gas formed after the degassing would need to be circulated to the incinerating step, rather than to the sulfur recovering step. Otherwise, the presence of N2, in particular the presence of N2 in such a great extent (resulting from air as stripping agent, comprising about 78% N2) may adversely affect the CO2 and/or H2 recovery step. Particularly, separation of CO2 and/or H2 may become more difficult in the presence of an increased amount of N2. Furthermore, if, using air as stripping agent, the gas formed after the degassing step is circulated to the SRU, an oversizing of the SRU (in one example) and all components/units downstream of the SRU thereof would be required. Circulating the gas formed after the degassing step to the incineration (when air is used as the stripping agent) requires more fuel gas to be burned, which negatively impacts emissions. The CO2 and/or H2 recovery step may be less effective if more N2 is present (e.g. if the gas formed from the degassing was circulated to the SRU if air is applied). Such less effectiveness may be caused by steric hindrance during CO2 and/or H2 recovery step.

Accordingly, using CO2 as the stripping agent for degassing precedently overcomes the disadvantages of using air as the stripping agent. In particular, the components and/or units can be kept small. As an example, no substantial oversizing is required. In addition, the amount of fuel gas for incinerating can be reduced. Accordingly, emissions are reduced.

In one example, CO2 may be used as stripping agent in combination with O2. The presence of O2 may facilitate oxidation and, thus, may enhance degassing. The inventors found measures to ensure a safe operation of O2 supply line. It may be possible to provide means to prevent introduction of too large amounts of O2 in the degassing, as this may cause sulfur fire, which may be violent and not easy to control.

Preferably, at least part of the recovered H2 is used as fuel for incinerating the off-gas.

This allows to burn H2 substantially directly as fuel in the incinerating step. In one examples, the recovered H2 may be used in combination with further fuels to provide the energy required for incinerating.

Preferably, 100% of the energy required for incinerating the off-gas is provided by the recovered H2.

This has the advantage that the recovered H2 may be used to completely replace traditional (and/or external) fuels. This promotes a further reduction of CO2 emissions.

In a preferred embodiment, the CO2 recovery step comprises:
using an adsorption process, such as a pressure swing adsorption (PSA) process, a cryogenic process or an absorption process, preferably using a PSA process or a cryogenic process to separate CO2 from the gaseous outlet stream downstream the sulfur recovery step to form a CO2 stream with a CO2 content of at least 94%, preferably at least 96%, more preferably at least 98%, most preferably at least 99%.

This has the advantage to increase CO2 recovery. Mostly, conventional solvents, such as amine-based solvents, are applied to recover CO2. Usually, such conventional means do not operate at favorable process conditions, e.g. amine based solvents operate at a lowest pressure within an overall plant and at high temperatures. This is detrimental for CO2 recovery and cost-intensive.

A pressure swing adsorption (PSA) process (it may also be termed a technique and/or technology) may be based on the principle that under increased pressure, gases tend to be trapped, e.g. trapped onto solid surfaces. Thus, gases may be adsorbed. It may be the case that an increased pressure leads to more gas being adsorbed.

Using the PSA process can significantly improve CO2 recovery. As an example a two-stage separation using PSA beds may be applied, wherein a first PSA bed may be used to separate CO2 and to form the recovered CO2 stream. The PSA process has the advantage that it can be easily integrated in the method as it is a well-established process for gas separation.

As the concentration of CO2 is increased in the gaseous outlet stream downstream the sulfur recovery step (since N2 is decreased due to oxygen enriched air), the PSA process is more efficient and cost-effective compared to solvent-based technologies.

It is understood that the gaseous outlet stream downstream the sulfur recovery step referred to herein may also be a gaseous outlet stream that has been further processed (e.g. in a treatment step and/or by increasing a pressure), as described herein.

It may also be possible to use a cryogenic process to separate CO2 and to form the recovered CO2 stream. A cryogenic process has the advantage that the OPEX can be reduced and that the (simultaneous) H2 recovery can be improved (e.g. by 2%). Furthermore, the cryogenic process may be operated in a more simplified manner. In one example, the gaseous outlet stream of the sulfur recovery step may be compressed and/or dehydrated (e.g. with a molecular sieve). Subsequently, CO2 separation may be performed, by pre-cooling the gaseous outlet stream to a temperature of at most −10° C., −20° C., −28° C., or even at most-40° C. before separation of the CO2. In one example, a propane refrigeration cycle may be used. In another example refrigeration with turbo-expander may be applied. Usage of a turbo-expander may have the advantage that CAPEX is reduced as no dedicated refrigeration cycle would be required. It may also be possible to use cooling water upstream the turbo-expander to reduce OPEX. After separation, a (dry, i.e. substantially water-free) recovered CO2 stream may be formed, which could be used e.g. for enhanced gas and/or oil recovery.

Preferably, the H2 recovery step comprises:
using an adsorption process, such as a pressure swing adsorption (PSA), a cryogenic process or an absorption process, preferably using a PSA process or a cryogenic process to separate H2 from the gaseous outlet stream downstream the sulfur recovery step to form a first H2 stream with an H2 content of at least 45%, preferably at least 48%, preferably at least 60%, more preferably at least 80%, even more preferably at least 90%, further more preferably at least 95%, most preferably at least 99.5%.

Similar advantages as explained herein with regard to the CO2 recovery step also apply to the H2 recovery step. As an example, before the H2 recovery step, a H2 concentration of at most ˜60% may prevail in a gaseous stream. The formed first H2 stream may also be referred to as the first recovered H2 stream.

As understood, the gaseous outlet stream downstream the sulfur recovery step referred to herein may also be a gaseous outlet stream that has been further processed (e.g. in a treatment step, by increasing a pressure and/or by a CO2 recovery step), as described herein.

In a further preferred embodiment,
when the CO2 recovery step comprises using a cryogenic process, H2 is separated substantially simultaneously with the separation of CO2 to form a second H2 stream, followed by an optional PSA process to form a third H2 stream, wherein the third H2 stream has a higher H2 content than the second H2 stream, wherein the first H2 stream is the second H2 stream or the third H2 stream;
when the CO2 recovery step comprises using a PSA process, a PSA process is used to separate H2 from a gaseous CO₂ recovery step outlet stream formed in the CO2 recovery step to form a fourth H2 stream, wherein, optionally, the first H2 stream is the fourth H2 stream.

A simultaneous separation of H2 and CO2 may be understood in such a manner that the second H2 stream is formed at substantially the same time as the recovered CO2 stream.

In one example, when the CO2 recovery step comprises using a cryogenic process, the simultaneously formed second H2 stream may have a H2 content of about at least 73%. Exemplarily, the gaseous outlet stream of the sulfur recovery step (that is dehydrated and/or cooled down, e.g. to about at least −40° C.) may be flashed in a cold flash vessel. Thereby, the recovered CO2 stream as a liquid stream and the second H2 stream as a flashed vapor stream may be formed. The H2 purity of the formed second H2 stream may be sufficient to be used as fuel (e.g. for incinerating).

When the CO2 recovery step comprises using a cryogenic process, the formed second H2 stream having at least about 73% H2 content may be sufficient, such that no optional PSA process for H2 recovery may be required. In another example, an optional PSA process for H2 recovery is indeed applied (e.g. for polishing) as described herein to form the third H2 stream. The first H2 stream could be the second H2 stream (e.g. if no optional PSA process is applied downstream the cryogenic process). The first H2 stream could be the third H2 stream (e.g. if the optional PSA process is applied downstream the cryogenic process).

When the CO2 recovery step comprises using a cryogenic process, an off-gas may be formed downstream the cryogenic CO2 recovery step and downstream the further and/or separate H2 recovery step by way of the PSA process. This off-gas may comprise CO2 (e.g. ˜68%), H2 (e.g. ˜8%), N2 (e.g. ˜12%), and remaining trace components. This off-gas may be circulated to the incinerating step for incinerating. In one example, this off-gas may be the gaseous H2 recovery step outlet stream as described herein, which is incinerated as off-gas. A required fuel for incinerating may be provided by the recovered H2 (e.g. it could be part of the off-gas itself, if the H2 content of the off-gas is sufficiently high, as described herein).

When the CO2 recovery step comprises using a PSA process, this may typically comprise applying a two-stage separation process using PSA beds as described herein. A second PSA bed may be used to separate H2 from the gaseous CO₂ recovery step outlet stream (e.g. the stream downstream the CO2 recovery step, which is not part of the recovered CO2 stream) to form the fourth H2 stream (which would be the first H2 stream as described herein). A residual gas may be formed downstream the H2 recovery step (e.g. downstream the second PSA bed), comprising H2 (e.g. ˜28%), N2 (e.g. ˜25%), CO2 (e.g. ˜8%), and remaining trace components. This residual gas may be routed to the incinerator for incinerating. A required fuel for incinerating may be provided by the recovered H2 (e.g. it could be part of the off-gas itself, if the H2 content of the off-gas is sufficiently high, as described herein).

Preferably, when the PSA process is used for CO2 recovery, also a PSA process is used for H2 recovery. This may be performed in a two-stage separation using PSA beds as described herein.

Preferably, the method further comprises:
a treatment step for treating the gaseous outlet stream of the sulfur recovery step to produce a gas comprising H2S and a gaseous outlet stream comprising CO2 and H2, wherein the produced gas comprising H2S is used as a third gaseous entry stream in the sulfur recovery step.

The treatment step may be performed in a tail gas treatment unit (TGTU). The TGTU may be applied to treat the gaseous outlet stream of the sulfur recovery step, such that sulfur compounds are reacted back to H2S. This may be achieved by catalytic reduction of oxidized sulfur compounds using reducing agent. The generated H2S may be circulated to the sulfur recovery step to increase the amount of recovered sulfur. In one example, the TGTU may use H2 as a reducing agent.

The TGTU may allow to control an amount of contaminants (e.g. COS, CS2, CH3SH) of the gaseous stream to comply with specified requirements. In one example, the TGTU may also facilitate to remove at least part of water of the gaseous outlet stream of the sulfur recovery step (if the gaseous outlet stream comprises water).

By way of the reduced amount of N2, the TGTU can be beneficially downsized, which reduces costs.

Preferably, the method further comprises:
increasing the pressure of the gaseous outlet stream produced in the treatment step to form a gaseous outlet stream with increased pressure, wherein, optionally,
when the CO2 recovery step comprises using a cryogenic process, the pressure of the gaseous outlet stream produced in the treatment step is increased from a range of between 0.1 to 1.0 bar gauge (barg) to a range of between 20 to 30 barg, preferably to a range of between 22 to 28 barg, most preferably to a range of between 24 to 26 barg; or
when the CO2 recovery step comprises using a PSA process, the pressure of the gaseous outlet stream produced in the treatment step is increased from a range of between 0.1 to 1.0 bar gauge (barg) to a range of between 30 to 60 barg, preferably to a range of between 40 to 50 barg, most preferably to a range of between 43 to 48 barg.

An increased pressure of the gaseous stream may facilitate CO2 and/or H2 recovery. In a most preferred embodiment for the cryogenic process of CO2 recovery, the pressure may be increased to 45 barg. In a most preferred embodiment for the PSA process of CO2 recovery, the pressure may be increased to 26 barg. Increasing the pressure may be performed with one or more (low pressure) compressors.

Preferably, the method further comprises dehydrating, using a glycol, such as triethylene glycol (TEG) the recovered CO2 stream downstream the CO2 recovery step.

Dehydration may be understood as removing water from a gas that stems from natural gas. Water may cause issues in components and/or units used of the method. Thus, removal of water is beneficial. Accordingly, a dehydrated CO2 facilitates its further usage.

As an example for dehydration, glycol dehydration may be applied. Glycol dehydration is a liquid desiccant system for the removal of water.

Glycols may include triethylene glycol (TEG), diethylene glycol (DEG), ethylene glycol (MEG), and tetraethylene glycol (TREG). TEG is advantageous to be used for dehydration.

Preferably, dehydrating downstream the CO2 recovery step is only performed if a PSA process for CO2 recovery is applied. This is because in case of the cryogenic process, a dehydrating step is preferably performed already upstream the CO2 recovery.

In a preferred embodiment, the method further comprises:
increasing the pressure of the recovered CO2 stream to a range of between 40 to 300 barg, preferably to a range of between 60 to 280 barg, more preferably to a range of between 100 to 260 barg, most preferably to a range of between 140 to 255 barg to form a recovered CO2 stream with increased pressure.

Increasing the pressure of the recovered CO2 stream facilitates that the recovered CO2 stream can be used efficiently for enhanced oil and/or gas recovery. Increasing the pressure may be performed with one or more (high pressure) compressors.

In a preferred embodiment, the method further comprises:
using at least part of the recovered CO2 stream downstream the CO2 recovery step for enhanced oil and/or gas recovery in a production field.

This may improve production of a field. As an example, CO2 may be injected into fields to increase an overall pressure of a reservoir of said field. This may promote forcing oil and/or gas towards production wells. The CO2 may also be blend with the oil and/or gas produced, which may facilitate its mobility and its properties when flowing.

Preferably, the method further comprises:
heating water, using the thermal energy of the sulfur recovery step, to form heated steam, preferably high pressure heated steam,
further heating the heated steam to form superheated steam, preferably high pressure superheated steam, wherein further heating is performed:
in the incinerating step, using the thermal energy of the incinerating step; preferably
in a separate step, using a superheating unit.

A gaseous stream within the sulfur recovery step may need to be cooled. Water (or any liquid stream) may be applied for such needed cooling. Said water may thus be heated by way of the thermal energy (occurring during oxidation reactions or the like). The water may be subjected to high pressure. Thus, high pressure heated stream may preferably be formed by way of heating using the thermal energy of the sulfur recovery step.

The heated steam may be further heated by using the thermal energy of the incinerating step. Thus, it may be heated by the off-gas as follows, as the off-gas is incinerated in the incinerating step. The off-gas that is incinerated may derive from the gaseous outlet stream produced in the sulfur recovery step after being processed within and/or downstream the CO2 and/or the H2 recovery step.

The further heating may be performed in a superheating unit that is separate to the unit in which incinerating is performed (e.g. separate to an incinerator unit). Thus, superheating could be performed more efficiently with a specifically designed superheating unit to maximize efficiency. As an example, it could be designed to make full use of radiative and convective heat transfer. The incinerator may merely be used during start-up, shut-down and/or upset scenarios.

Preferably, the off-gas derived from the gaseous outlet stream that is incinerated is at least part of:
the gaseous outlet stream;
a gaseous CO₂ recovery step outlet stream formed in the CO2 recovery step; and/or
a gaseous H2 recovery step outlet stream formed in the H2 recovery step.

It is possible that incinerating of off-gas is performed that is a part of the gaseous outlet stream produced in the sulfur recovery step. This may be the case, for instance if it is desired that an amount of such gaseous outlet stream is incinerated (e.g. during start-up, shut-down and/or upset scenarios).

It may also be possible that this gaseous outlet stream may have undergone further method steps (e.g. the CO2 recovery step and/or the H2 recovery step), before being incinerated.

The incinerator may serve the purpose that substantially no H2S is released to the atmosphere.

A further aspect of the invention relates to a system for sulfur (S), carbon dioxide (CO2) and hydrogen (H2) recovery from a gaseous stream comprising hydrogen sulfide (H2S) and CO2, the system comprising means for carrying out the method as described herein.

The system has the advantage of performing the previously presented method according to the present invention. Thus, the same advantages mentioned in the context of the method are likewise applicable to the system.

Preferably, the system comprises:
means for providing a first gaseous entry stream and optionally a second gaseous entry stream, both comprising hydrogen sulfide (H2S) and CO2;
a sulfur recovery unit (SRU) for recovering sulfur (S) from at least part of the H2S provided with the gaseous entry stream(s) to produce a liquid phase comprising sulfur (S),
   wherein recovering comprises a reaction of the gaseous entry stream(s) with oxygen enriched air, wherein the oxygen enriched air contains preferably at least 30%, more preferably at least 40%, more preferably at least 50%, more preferably at least 60%, more preferably at least 70%, more preferably at least 80%, more preferably at least 90%, more preferably at least 95%, most preferably at least 98.5% oxygen,
   wherein the SRU also produces a gaseous outlet stream comprising CO2 and H2;
a CO2 recovery unit for recovering at least part of the CO2 provided with the gaseous outlet stream;
an H2 recovery unit for recovering at least part of the H2 provided with the gaseous outlet stream;
an incinerator unit for incinerating an off-gas derived from the gaseous outlet stream, wherein at least 50%, preferably at least 55%, more preferably at least 60%, more preferably at least 65%, more preferably at least 70%, more preferably at least 75%, more preferably at least 80%, more preferably at least 85%, more preferably at least 90%, most preferably at least 95% of an energy required for the incinerating is provided by the recovered H2.

In a preferred embodiment, the system further comprises:
a degassing unit, for degassing, using a stripping agent, preferably using no ambient air as the stripping agent, at least part of residual H2S contained in the liquid phase comprising sulfur (S) to form the second gaseous entry stream comprising gaseous H2S and at least part of the stripping agent.

Preferably, the CO2 recovery unit comprises:
a cryogenic unit having a molecular sieve unit for dehydration of the gaseous outlet stream, a refrigeration unit for cooling the gaseous outlet stream and a cryogenic purification unit for separating CO2 from the gaseous outlet stream downstream the SRU; or
a pressure swing adsorption (PSA) unit comprising one or more adsorption beds for separating a CO2 from the gaseous outlet stream downstream the SRU;
wherein the CO2 recovery unit is configured to form a recovered CO2 stream with a CO2 content of at least 94%, preferably at least 96%, more preferably at least 98%, most preferably at least 99%.

In a preferred embodiment, the H2 recovery unit is part of the CO2 recovery unit and/or the H2 recovery unit comprises:
a pressure swing adsorption (PSA) unit comprising one or more adsorption beds for separating H2 from the gaseous outlet stream downstream the sulfur recovery step;
wherein the H2 recovery unit is configured to form a first, second, third and/or fourth H2 stream with an H2 content of at least 45%, preferably at least 48%, preferably at least 60%, more preferably at least 80%, even more preferably at least 90%, further more preferably at least 95%, most preferably at least 99.5%.

It may be possible that the H2 recovery step may be performed substantially simultaneously with the CO₂ recovery step. In such a case, the H2 recovery unit may be part of the CO2 recovery unit. Particularly, this may be the case if a cryogenic process for CO2 recovery is used. A simultaneous separation (e.g. forming) of H2 and CO2 may be understood in such a manner that the second H2 stream is formed at substantially the same time as the recovered CO2 stream.

It may also be feasible that the H2 recovery unit comprises a PSA unit that is separate to the CO2 recovery unit.

Preferably, the system further comprises:
a tail gas treatment unit (TGTU) for treating the gaseous outlet stream of the SRU to produce a gas comprising H2S and a gaseous outlet stream comprising CO2 and H2, wherein the produced gas comprising H2S is used as a third gaseous entry stream in the SRU.

In a preferred embodiment, the system further comprises:
a low pressure (LP) compressor arranged between the SRU and the CO2 recovery unit for increasing the pressure of the gaseous outlet stream produced in the TGTU to form a gaseous outlet stream with increased pressure,
wherein the LP compressor is preferably configured:
   to increase the pressure from a range of between 0.1 to 1.0 bar gauge (barg) to a range of between 20 to 30 barg, preferably to a range of between 22 to 28 barg, most preferably to a range of between 24 to 26 barg; or
   to increase the pressure from a range of between 0.1 to 1.0 bar gauge (barg) to a range of between 30 to 60 barg, preferably to a range of between 40 to 50 barg, most preferably to a range of between 43 to 48 barg.

Preferably, the system further comprises:
a dehydration unit, preferably a glycol, such as triethylene glycol (TEG) dehydration unit for dehydrating the recovered CO2 stream downstream the CO2 recovery unit.

In a preferred embodiment, the system further comprises:
one or more high pressure (HP) compressor(s) downstream the CO2 recovery unit for increasing the pressure of the recovered CO2 stream to a range of between 40 to 300 barg, preferably to a range of between 60 to 280 barg, more preferably to a range of between 100 to 260 barg, most preferably to a range of between 140 to 255 barg to form a recovered CO2 stream with increased pressure.
Preferably, the SRU is configured to heat water, using the thermal energy of the SRU, to form heated steam, preferably high pressure heated steam.
In a preferred embodiment, the incinerator unit is configured to further heat the heated steam, using the thermal energy of the incinerator unit, to form superheated steam, preferably high pressure superheated steam.

Preferably, the system further comprises:
a superheating unit to further heat the heated steam to form superheated steam, preferably high pressure superheated steam.

Another aspect of the invention relates to a computer program comprising instructions which, when the program is executed by a computer, cause the computer to control and/or to carry out the method and/or the system as described herein.

It is noted that the method steps as described herein may include all aspects and/or embodiments described herein, even if not expressly described as method steps but rather with reference to a system (or device or apparatus). It is also to be understood that the features and advantages described with reference to a system (or device or apparatus) may equally be applicable to the method steps. Moreover, the system (or device or apparatus) as outlined herein may include means for implementing all aspects and/or embodiments as outlined herein, even if these may rather be described in the context of method steps. Furthermore, the features and advantages described with reference to the method steps may equally be applicable to the system (or device or apparatus).

Whether described as method steps, computer program and/or means, the functions described herein may be implemented in hardware, software, firmware, and/or combinations thereof. If implemented in software/firmware, the functions may be stored on or transmitted as one or more instructions or code on a computer-readable medium. Computer-readable media include both computer storage media and communication media including any medium that facilitates transfer of a computer program from one place to another. A storage medium may be any available media that can be accessed by a general purpose or special purpose computer. By way of example, and not limitation, such computer-readable storage media can comprise RAM, ROM, EEPROM, FPGA, CD/DVD or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

### 4. BRIEF DESCRIPTION OF THE FIGURES

In the following, preferred embodiments are described, by way of example only. Reference is made to the following accompanying figures:

FIG. 1 is a schematic view of a conventional method and/or system of sulfur and carbon dioxide recovery;

FIG. 2 is a schematic overview of a method and/or system of sulfur, carbon dioxide and hydrogen recovery according to an embodiment of the invention;

FIG. 3 is a schematic view of a method and/or system of sulfur, carbon dioxide and hydrogen recovery according to an embodiment of the invention;

FIG. 4 is a schematic view of a method and/or system of sulfur, carbon dioxide and hydrogen recovery according to another embodiment of the invention;

FIG. 5 is a detailed schematic view of an SRU, TGTU, sulfur degassing unit and an incinerator according to a conventional method and/or system;

FIG. 6 is a detailed schematic view of an SRU, TGTU, sulfur degassing unit and an incinerator according to an embodiment of the invention; and

FIG. 7 is a flow chart of a method of sulfur, carbon dioxide and hydrogen recovery according to an embodiment of the invention.

FIG. 8 is a flow chart of a system of sulfur, carbon dioxide and hydrogen recovery according to an embodiment of the invention.

### 5. DETAILED DESCRIPTION OF THE FIGURES

### Definitions

The terms “SOx”, as used herein may be understood as SO2 and/or SO3 or the like.

The terms “NOx”, as used herein may be understood as species comprising N and O, such as NO and/or NO2 or the like.

The terms “recovery”, “recovering” and/or “to recover” as used herein may be understood as to get a compound/species back and/or to retrieve, regain, capture a compound/species. In some embodiments the terms may also be understood in that a compound/species is retrieved and recirculated/reused in the method and/or system as described herein.

The term “oxygen enriched air” as used herein may be understood as air, wherein the oxygen content is increased. For instance, air comprises about 78% N2, about 21% oxygen and further component such as argon, CO2 and remaining gases. Enriching the oxygen content of air may be understood such that at least 96% of the oxygen enriched air is oxygen. Enriching may be achieved by an air separation unit (ASU).

The term “recovered CO2 stream” may also be understood as “recovered CO2”. It should be understood as a stream comprising a relatively high concentration of CO2.

The term “recovered H2 stream” may also be understood as “recovered H2”. It should be understood as a stream comprising a relatively high concentration of H2.

The term “gaseous” as used herein may be understood as relating to or having the characteristics of a gas. A gas may represent one of three fundamental states, next to the “liquid” and “solid” state.

The term “blue hydrogen” as used herein may be understood such that a gas, such as a natural gas, or a gas comprising hydrocarbons is split into hydrogen and CO2 and the CO2 is captured and preferably stored.

The term “sour gas” as used herein, may be understood as any gas that contains hydrogen sulfide (H2S) in substantial amounts.

The term “acid gas” as used herein, may be any gas that contains substantial amounts of acid gases such as carbon dioxide (CO2) or hydrogen sulfide (H2S). Acid gas may be part of a “feed gas” from a reservoir.

The term “flue gas” may, in some examples, be understood as a gaseous outlet stream.

An “off-gas” may also be termed reject stream, e.g. a gas which may usually be referred to as not being useful. However, the present disclosure can advantageously make use of such an off-gas.

The term “degassing” may be understood as at least partially removing at least one gaseous compound/species from a liquid phase.

The term “stripping agent” may be understood as any agent that can facilitate a physical separation process. A physical separation process may be a process where one or more components may be removed from a liquid.

A “tail gas” may be understood as a gas leaving a component/unit. In some examples, it may also be understood as a gaseous outlet stream.

The term “bar gauge” (barg) as used herein may be understood as the unit to express the pressure relative to the ambient pressure. As an example, 5 bar gauge may be 6 bar in absolute terms if the ambient pressure is 1 bar.

A “standard cubic foot” (scf) is a unit used both in the natural gas industry to represent an amount of natural gas and in other industries where other gases are used. A standard cubic foot defines an amount of gas contained in a volume of one cubic foot at standard temperature and pressure (15° C. (288.150 K; 59.000° F.) and 101.325 kilopascals (1.0000 atm; 14.696 psi)). 1 scf corresponds to 0.02831685 sm³.

“Million standard cubic feet” (MMSCF) is a unit of measurement for gases. MMSCFD is commonly used as a measure of natural gas, liquefied petroleum gas, compressed natural gas and other gases that are extracted, processed or transported in large quantities. 1 MMSCF corresponds to 28316.85 m³.

“Million standard cubic feet per day” (MMSCFD) is the unit of MMSCF referred to one day.

“Hydrocarbon” is an organic compound consisting (entirely) of hydrogen and carbon.

In the term “H2Sn”, n is to be understood as any integer greater than 1.

A “content” (of a species) may, in some examples, also be understood as a concentration (of a species).

The terms “circulating” (or to “circulate”), “routing” (or to “route”) and/or “entering” (or to “enter”) may have a similar meaning. As an example, a gaseous stream being circulated from A to B may be understood as a gaseous stream being routed from A to B and/or as a gaseous stream entering B.

### Description of the Figures

Subsequently, presently preferred embodiments will be outlined, primarily with reference to the above Figures. It is noted that further embodiments are certainly possible, and the below explanations are provided by way of example only, without limitation. Further, the present invention can also be used in other embodiments not explicitly disclosed hereafter. Moreover, as detailed below, the embodiments are compatible with each other, and individual features of one embodiment may also be applied to another embodiment.

While specific feature combinations are described in the following with respect to the exemplary embodiments of the present invention, it is to be understood that not all features of the discussed embodiments have to be present for realizing the invention, which is defined by the subject matter of the claims. The disclosed embodiments may be modified by combining certain features of one embodiment with one or more features of another embodiment. Specifically, the skilled person will understand that features, components and/or functional elements of one embodiment can be combined with technically compatible features, components and/or functional elements of any other embodiment of the present invention given that the resulting combination falls within the definition of the invention provided by the claims. The skilled person also understands that certain features may be omitted in so far as they appear dispensable.

Throughout the present figures and specification, the same reference numerals refer to the same elements. The figures may not be to scale, and the relative size, proportions, and depiction of elements in the figures may be exaggerated for clarity, illustration, and convenience.

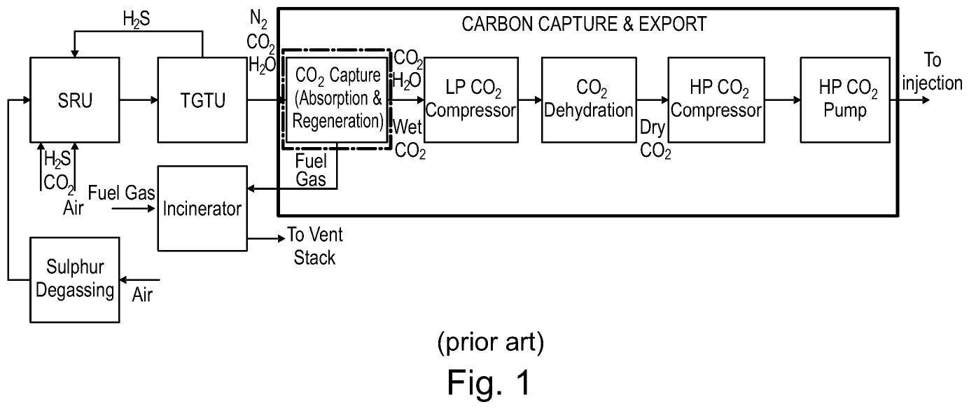

FIG. 1 is a schematic view of a conventional method and/or system of sulfur and carbon dioxide recovery.

A gaseous stream comprising hydrogen sulfide (H2S) and CO2 enters a sulfur recovery unit (SRU). The gaseous stream may also comprise further species, such as water H2O and hydrocarbons. Typically, the gaseous stream stems from natural gas, which has been undergone an acid gas removal process, e.g. in an acid gas removal unit (AGRU). An AGRU is designed to remove the acidic components from natural gas. The extent to which such removal takes place may be subject to meeting sales gas sulfur and CO2 specifications. The gas from the SRU is guided to a tail gas treatment unit (TGTU).

Air also enters the SRU in this example according to a conventional system. Within the SRU a Claus reaction using air is performed and part of the sulfur in the gaseous stream is recovered. A gaseous outlet stream is produced in the SRU that still contains a sizeable amount of sulfur dioxide (SO2), sulfides, carbonyl sulfide (COS) and carbon disulfide (CS2). H2S may be captured in the TGTU and circulated back to the SRU.

Part of a gaseous stream produced in the SRU and/or the TGTU may also be directed to the incinerator (the connection line is not shown in this figure). Notably, in case conventional methods do not apply CO2 recovery, the overall amount of the gaseous outlet stream of the TGTU is directed to the incinerator. In case conventional methods apply CO2 recovery, the overall amount of the gaseous outlet stream of the CO2 recovery is directed to the incinerator. In the incinerator, gases of H2S, COS and CS2 that may still be present are converted into less noxious compounds, such as SOx, CO2, H2O, and NOx. Fuel gas is required for the incinerator, which causes CO2 emissions.

A gaseous outlet stream of the SRU and of the TGTU comprises considerable amounts of N2 due to the air entering the SRU. Furthermore, the gaseous outlet stream of the TGTU comprises CO2, H2 (traces) and H2O as indicated in this figure. The gaseous outlet stream of the TGTU enters a CO2 capture unit downstream of the TGTU. Flue gas thereof enters the incinerator. Furthermore, CO2, H2O and wet CO2 enter a downstream low pressure (LP) CO2 compressor, then a dehydration is performed to produce dry CO2, which enters first a high pressure (HP) CO2 compressor and subsequently a HP CO2 pump. A solvent-based absorption is applied to capture CO2, which is common and widely used for acid gas removal units to remove H2S and CO2 from feed gas from reservoir.

The solvent of the CO2 capture unit is mostly amine based and reacts selectively with the CO2. The rich solvent (reacted with CO2) can be regenerated by steam stripping and the CO2 can then be released from said stripper for compression and export. The regenerated solvent can be recycled back for CO2 capture. This process may be simplified in this figure by the unit termed “CO2 Capture (Absorption & Regeneration)”.

A sulfur degassing unit is applied that operates using air as a stripping agent to remove H2S and/or H2Sn from liquid sulfur. Under condenser operating conditions of a part and/or subcomponent of an SRU, the dissolved H2S reacts with elemental sulfur to form polysulfides (H2Sn, with n>1). These H2Sn slowly and naturally decompose to form sulfur and H2S. Liquid sulfur, if not degassed, would be risky due to the release of flammable, toxic, corrosive H2S. Such removed H2S is oxidized in considerable amounts in the incinerator (the connection line is not shown), causing significant amounts of CO2 to be exhausted to the atmosphere. In addition, such an incinerator requires additional fuel gas for operation. It may also be possible, as shown in FIG. 1 for conventional methods, that, if air is used as a stripping agent, the gaseous outlet of the sulfur degassing is routed to the SRU.

The conventional method and/or system is uneconomical. For instance, the solvent operates in unfavorable conditions. The efficiency of amine-solvent is higher at higher pressure (e.g. above 20 barg). However, the operating pressure of this method is about atmospheric (˜0.1 barg). Compression may alleviate this, but this would increase costs considerably. Furthermore, flue gas from the CO2 capture unit needs to be mixed with large amounts of fuel gas to make the mixture combustible. Considerable amounts of N2 present in the gas require increased sizes of components and/or units. Further, H2 capture is not foreseen.

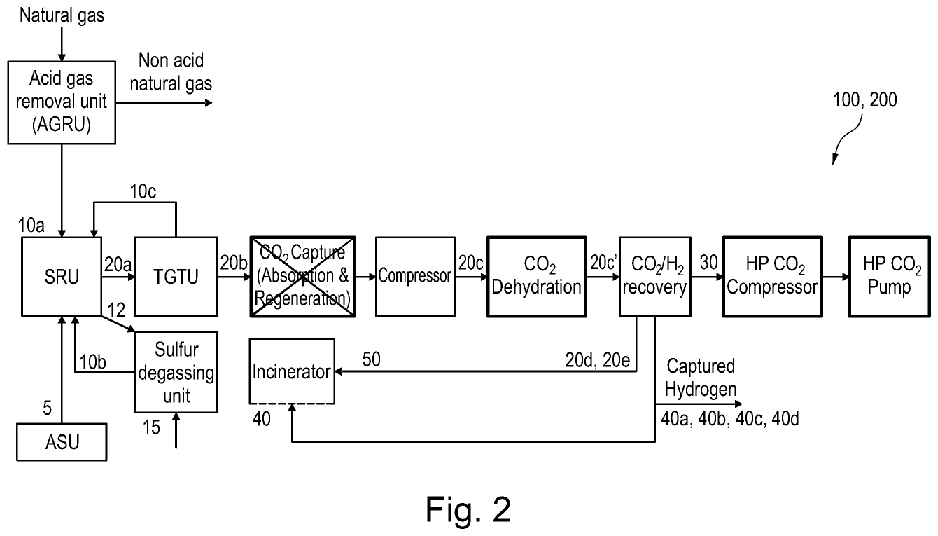

FIG. 2 is a schematic overview of a method 100 and/or system 200 of sulfur, carbon dioxide and hydrogen recovery according to an embodiment of the invention. Some but not all differences to the conventional method and/or system of FIG. 1 are shown.

In this embodiment, the SRU is provided with oxygen enriched air 5 and a first gaseous entry stream 10a comprising hydrogen sulfide (H2S) and carbon dioxide CO2.

The level of enrichment may be at least 90%, or at least 95% or even higher. This essentially eliminates the N2 in the SRU and in a gaseous outlet stream 20a produced by the SRU. This also applies to the gaseous outlet stream 20b of the TGTU. This increases the concentration of CO2 in the gaseous outlet stream 20a (and 20b), i.e. the amount of CO2 could be about 70% in the gaseous outlet stream 20a.

The SRU may comprise a thermal stage in which H2S may be partially combusted to SO2. A major part of residual H2S may thermally react to S by reaction with SO2. This may result in a liquid phase 12 comprising sulfur (S). Hydrocarbons within the gaseous stream entering the SRU may be burned to CO2 and H2O. It may be possible that COS and/or CS2 are formed as by-products in small amounts (these could be removed in the 1^{st} stage Clause Reactor, e.g. in the SRU, and/or the TGTU as described herein).

It may be feasible to locate an H2S/SO2 or air-demand analyzer in proximity to the gaseous outlet stream 20a of the SRU (e.g. in proximity to a tail gas line of the SRU) to continuously monitor the value of “H2S−3×SO2” which should be zero in one example. The data obtained from the analyzer may be used to adjust an enriched oxygen 5 flow to the SRU (e.g. to the thermal stage of the SRU). Thermal energy of the SRU may be heat that is generated in the thermal stage of the SRU. This thermal energy may be used to form high pressure heated steam 60a from water 60 as described herein. Thereby gaseous streams within the SRU may be cooled.

At such rather high concentration of CO2, more efficient CO2 recovery processes can be applied instead of conventional solvent-based recovery processes of the preceding figure. This is more cost-effective. Furthermore, the sizes of the components and/or units can be reduced (e.g. downsized), as the amount of N2 is substantially reduced.

This further reduces costs.

The oxygen enriched air 5 may lead to increased temperatures within the SRU, e.g. temperatures of at least 1100° C., at least 1250° C., at least 1350° C. or at least 1500° C. The oxygen enriched air 5 facilitates producing H2 as part of the gaseous outlet stream 20a of the SRU. Thus, a co-production of H2 is enhanced in the SRU (next to recovering sulfur in a liquid phase 12). This may be caused by a thermal decomposition reaction according to:

H₂S→H₂+S.

Furthermore, an improved reaction of the first gaseous entry stream 10a to H2 as part of the gaseous outlet stream 20a of the SRU may be provided within the SRU (e.g. in catalytic stages). This substantially applies to all gaseous entry streams 10 (e.g. 10a, 10b, 10c, although not all are shown in this figure). Such improved reaction may be caused by an increased partial pressure of H2S. In one example, the improved reaction may be provided by way of reaction kinetics, e.g. the thermal decomposition favors higher temperatures, which, in turn, improves the reaction.

The oxygen enriched air 5 may be provided by an air separation unit (ASU). As an example, an ASU separates atmospheric air into its primary components, typically nitrogen and oxygen, and sometimes also argon and other rare inert gases. For instance, fractional distillation may be used for air separation. Operation of the ASU may require some means. However, compared to the benefits of the method and/or system described herein, providing such means and/or operating the ASU do not adversely affect the reduction of emissions.

Exemplarily, the figure shows a tail gas treatment unit (TGTU). The gaseous outlet stream 20a produced in the SRU may be guided to the TGTU. In the TGTU, a treatment step may be performed, such that sulfur compounds comprised in the gaseous outlet stream 20a of the SRU are reacted such that a gas comprising H2S 10c is produced. This may be achieved by catalytic reduction of oxidized sulfur compounds using reducing agent (e.g. H2). The produced gas comprising H2S 10c may be circulated to the SRU and used as a third gaseous entry stream 10c in the SRU, which can increase the amount of recovered sulfur (S). The TGTU may allow to control an amount of contaminants (e.g. COS, CS2, CH3SH) of the gaseous stream to comply with specified requirements. The TGTU also produces a gaseous outlet stream 20b comprising CO2 and H2 (their concentration is increased compared to the prior art as described herein), which may be further processed in downstream units.

The figure shows a crossed out box to indicate that the conventional CO2 Capture process of the prior art of FIG. 1 is not performed according to the embodiment of FIG. 2 of this disclosure. Rather, the “CO2/H2 recovery step” is shown as described herein.

As an example, the figure also shows a degassing unit, for degassing, using a stripping agent 15, at least part of residual H2S contained in the liquid phase 12 comprising sulfur (S) to form a second gaseous entry stream 10b comprising gaseous H2S and at least part of the stripping agent 15. The second gaseous entry stream 10b is provided to the SRU. Thus, the amount of sulfur recovered can be further increased.

It is to be noted that at least part of the recovered sulfur (S) comprised in the liquid phase may be stored. As an example, it may be stored in a sulfur pit. It may also be shipped as a product and/or used for the production of sulfuric acid for sulfate and phosphate fertilizers, and/or other chemical processes.

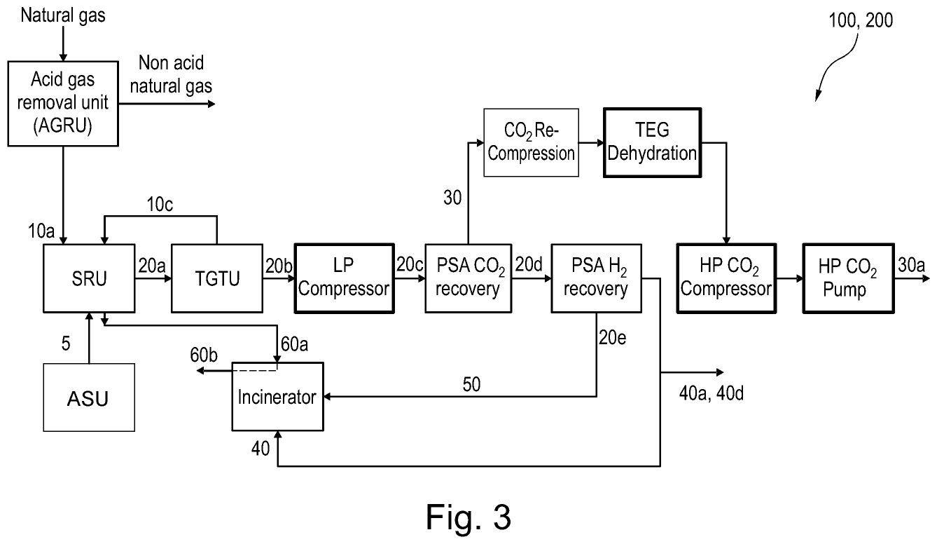

FIG. 3 is a schematic view of a method 100 and/or system 200 of sulfur, carbon dioxide and hydrogen recovery according to an embodiment of the invention. Not all shown components and/or units may be required.

A first gaseous entry stream 10a comprising hydrogen sulfide (H2S) and carbon dioxide (CO2) is provided. The first gaseous entry stream 10a is an acid gas (as it comprises acid gases). The first gaseous entry stream 10a may further comprise water (H2O) and/or hydrocarbons. As an example, the first gaseous entry stream 10a may be derived from natural gas, which is processed in an acid gas removal unit (AGRU) as indicated in this figure by way of example only.

The provided first gaseous entry stream 10a enters an SRU, wherein a sulfur recovery step for converting at least part of the H2S provided with the first gaseous entry stream 10a to elemental sulfur is performed. The SRU may comprise two steps, e.g. a thermal/combustion reaction step and a combustion/catalytic reaction step. Sulfur may be recovered in all steps. Converting comprises a reaction of the gaseous stream with oxygen (O2) enriched air 5, which enters the SRU. Oxygen enriched air 5 contains at least 96% oxygen, preferably at least 98.5% oxygen. This has the advantage that the nitrogen (N2) content (which is usually present in air in large amounts) is reduced. The N2 content could be reduced to at most 4% or at most 1.5%. Thus, the SRU can be designed to be smaller (downsized), compared to an SRU wherein air is used.

The sulfur recovery step performed in the SRU produces a gaseous outlet stream 20a comprising CO2 and H2. There may also be further components such as H2O comprised in the gaseous outlet stream 20a.

The figure also shows a TGTU, which produces a third gaseous entry stream 10c comprising CO2 and H2 to be provided to the SRU and a gaseous outlet stream 20b (as already described with reference to the preceding figure).

A CO2 recovery unit is shown for recovering at least part of the CO2 provided with the gaseous outlet stream 20a to form a recovered CO2 stream 30. The CO2 recovery step preferably takes place in a pressure swing adsorption (PSA) CO2 recovery unit. The working principle of an PSA may be understood as follows: PSA comprises a physical separation process that allows small molecules, e.g. H2, to pass through whilst trapping larger molecules (the adsorbate), e.g. CO2. The adsorbate is then recovered by low pressure desorption as off-gas. Typically a recovered CO2 stream 30 having a CO2 content of about at least 98% or at least 99% is formed by way of the PSA CO2 recovery unit.

A H2 recovery unit is depicted for recovering at least part of the H2 provided with the gaseous outlet stream 20a to form a first H2 stream 40a. As the CO2 recovery step comprises using a PSA process, the formed first H2 stream 40a corresponds to the fourth H2 stream 40d within the meaning of the present disclosure. The H2 recovery step takes place in a pressure swing adsorption (PSA) H2 recovery unit. The gaseous outlet stream 20d, which enters the PSA H2 recovery unit, may be the gaseous CO₂ recovery step outlet stream 20d (e.g. gaseous CO₂ PSA recovery step outlet stream).

The gaseous outlet stream 20d of the PSA CO2 recovery unit may already have an H2 content of about 60%. The PSA H2 recovery unit serves the purpose to achieve an increased H2 content (e.g. to comply with a required specification of H2 content). This may be useful for a condensate hydrotreater unit (CHT), which could demand an H2 content of about 99.5%. The H2 recovery step may not be necessary if such purity of H2 is not required.

The gaseous H2 recovery step outlet stream 20e produced in the PSA H2 recovery unit mainly contains H2 (˜28%), N2 (˜25%), CO2 (˜8%), and further contains remaining trace components. This gaseous H2 recovery step outlet stream 20e is preferably routed to the incinerator as off-gas 50 as shown in this figure. Contaminants such as H2S, COS and CO may also be present in the off-gas 50. Preferably the off-gas 50 is routed to the incinerator, which ensures resilience against variations in the contents of species of the gaseous H2 recovery step outlet stream 20e (e.g. compositional changes). Subsequently, it is vented to the atmosphere.

The incinerator is employed for incinerating off-gas 50 (which could comprise H2S) downstream the sulfur recovery unit (e.g. downstream the sulfur recovery step). In some examples, the incinerator may be arranged downstream the TGTU. It may, in some cases, possible that the incinerator is a part of the TGTU, e.g. a downstream part of the TGTU. For instance, if a TGTU is not provided in a method and/or system, the incinerator may be arranged (directly) downstream the SRU. At least 70%, preferably at least 80%, more preferably at least 90%, most preferably at least 95% of an energy required for the incinerating is provided by the recovered H2 (this is indicated by reference numeral 40). In one example, the H2 of the off-gas may be at least part of the recovered H2, which provides the energy for incineration, if the H2 content of the off-gas is sufficiently high, as described herein. As an example, in the incinerator, residual amounts of H2S may thermally react to SO2 (e.g. oxidized). It is also possible that 100% of the energy required for incinerating is provided by the recovered H2. The energy could be provided directly, e.g. by burning recovered H2 as fuel 40.

Preferably the incinerator operates at minimum throughput, e.g. a minimum amount of volume and/or mass flow is guided through it. It may be the case, that the incinerator merely operates at start-ups and/or upsets (e.g. if more gaseous streams (10, 10a, 10b, 10c) are provided to the SRU).

The SRU may also serve the purpose to heat water 60 (e.g. from a separate water cycle) to form heated steam 60a, such as a high pressure heated steam. The heated steam 60a may be produced in the SRU by thermal energy (e.g. waste heat) of the SRU, thereby cooling the gaseous streams within the SRU (at the same time).

The incinerator may increase a temperature of the heated steam 60a (using the thermal energy of the incinerating step) to produce high pressure superheated steam 60b. This may be useful to be applied as a heat source. The incinerator may also be used as hot stand-by in case a TGTU encounters an upset, as described herein. The heated steam 60a and the superheated steam 60b may be a separate cycle (e.g. the steam does not chemically react with gaseous components in the incinerator), this is indicated by the dotted line in the box of the incinerator in this figure.

An LP compressor may be provided upstream the PSA CO2 recovery to increase a pressure from about 0.12 to 26 barg. The pressure loss between the two PSA recovery units may be small. Thus, the gaseous outlet stream 20d of the PSA CO2 recovery unit is available at adequate pressure. Accordingly, it is appreciated that no compressor may be required between the two PSAs (e.g. the PSA CO2 and PSA H2 recovery unit).

Downstream the PSA CO2 recovery unit, a compressor (e.g. a CO2 re-compression unit) may increase the pressure of the CO2 recovery stream 30 to about 39 barg.

Furthermore, dehydration may be performed to meet typical injection specifications (˜19 lb/MMSCF, i.e. 19*0.4536 kg/28316.85 m³ ˜0.000304 kg/m³). This is done using a triethylene glycol (TEG) based unit termed “TEG dehydration” in this figure.

The recovered CO2 stream leaving the TEG dehydration unit may enter an HP CO2 compressor to increase a pressure from about 27 to 175 barg. The recovered CO2 stream may then enter a HP CO2 pump to increase a pressure from about 175 to 250 barg to form recovered CO2 stream 30a with increased pressure. The recovered CO2 stream at such an increased pressure may be used as an injection gas, i.e. to enhance recovery in (depleted) gas and/or oil reservoirs.

A part of the recovered H2 stream (e.g. the first H2 stream 40a, which equals the fourth H2 stream 40d) downstream the H2 recovery step may be guided to a condensate hydrotreater unit (CHT, not shown in this figure). Traditionally a hydrogen production unit (HPU) serves the purpose to provide for H2. However, advantageously, a large amount of H2 can be provided by the H2 recovery step according to the present disclosure. Thus, the traditional HPU can be downsized by virtue of the provided recovered H2 stream (40a, 40d).

For instance, a traditional HPU designed for 27 MMSCFD (764554.95 m³) may be downsized to about between 10 MMSCFD (283168.5 m³) or 7 MMSCFD (198217.95 m³). This may depend on the process (or technique and/or technology) applied in the CO2 and/or H2 recovery step (e.g. using PSA as described in this figure or a cryogenic process as described in another figure). Accordingly, the HPU can be beneficially downsized to supply the balance of H2 to the CHT, e.g. in case a deficit of recovered H2 stream occurs. Thus, a CHT demand may be ensured. In contrast to traditional applications, the downsized HPU reduces costs significantly as it simultaneously makes use of H2 recovered in an upstream unit.

The described embodiment has the advantage that the oxygen enriched air 5 guided into the SRU results in increased H2 production in the SRU. This facilitates recovering H2, which provides a unique opportunity for further taking advantage of the recovered H2 stream (40a, 40d) to reduce CO2 emissions as described herein. This may particularly be the case, if H2 is consumed in the condensate hydrotreater (CHT) and can thus be refilled without substantial emissions.

The above embodiment has the advantage that a CO2 recovery of ˜99.4% can be achieved compared to 90% using traditional applications. Furthermore, a H2 recovery of about 85% can be achieved. Significant reduction in CO2 emissions are achieved, e.g. about 67% compared to traditional applications. Furthermore, it has the advantage that the units may be individually provided such that substantially no reliance on (single) company property is required.

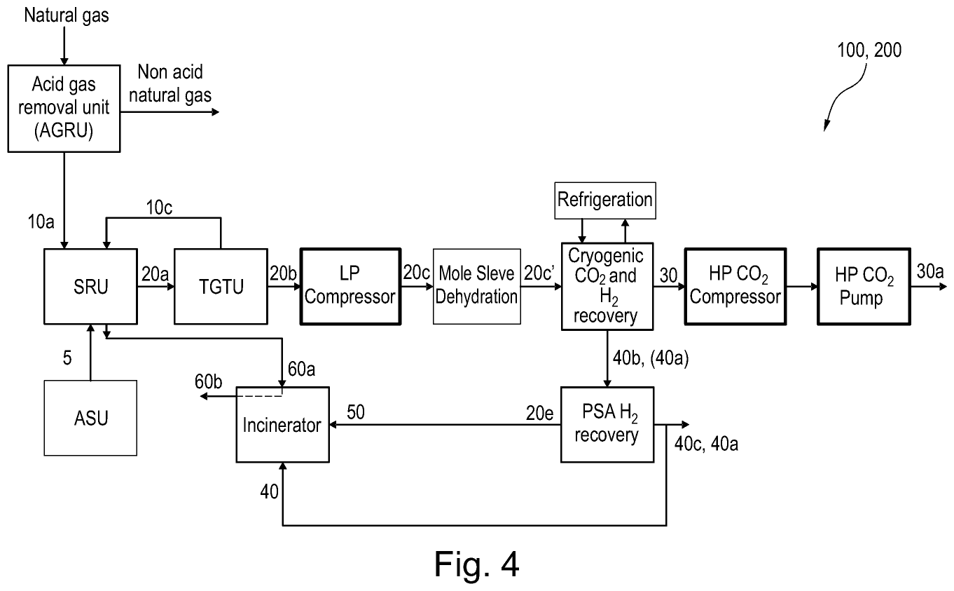

FIG. 4 is a schematic view of a method and/or system of sulfur, carbon dioxide and hydrogen recovery according to another embodiment of the invention. The embodiment is similar to the one of FIG. 3 and only the differences to FIG. 3 are described.

A cryogenic process is used for CO2 recovery compared to a PSA recovery of FIG. 3. The cryogenic process may also be referred to as cold-flash process.

A gaseous outlet stream 20b from the TGTU (comprising CO2, H2 and H2O) is compressed, e.g. in an LP compressor provided upstream the PSA CO2 recovery to increase a pressure from about 0.12 to 45 barg. Thereby, a gaseous outlet stream 20c with increased pressure is formed.

Further, the gaseous outlet stream 20c with increased pressure may be dehydrated with a molecular sieve (it could be dehydrated to about at most 0.1 ppmv, parts per million in volume, of water). A molecular sieve may be understood as a material with pores. The pores could be of uniform size. The pore diameters may be similar in size to small molecules, and thus large molecules may not enter or may not be adsorbed, while smaller molecules may enter and may be adsorbed. Accordingly, the gaseous outlet stream 20c′ of the molecular sieve is substantially dry.

Subsequently the gaseous outlet stream 20c′ of the molecular sieve may be subjected to a cold flash process where it is first pre-cooled, e.g. pre-cooled down to about −28° C. and then further cooled to −40° C. with a refrigeration cycle. Said refrigeration cycle may be a propane refrigeration cycle. The CO2 recovery takes place in the cryogenic H2 recovery unit shown in the figure.

The recovered CO2 stream 30 (by way of the cryogenic H2 recovery unit) may have a purity of about 98% and is guided to an HP CO2 compressor (for increasing a pressure from 40 to 180 barg). Subsequently, it may be guided to a HP CO2 pump (for increasing a pressure from 180 to 250 barg) to form recovered CO2 stream with increased pressure 30a. It may then be used, e.g. for injection in a gas and/or oil field as described herein.

H2 is recovered substantially simultaneously with the recovery of CO2 to form a second H2 stream 40b. The second recovered H2 stream 40b (by way of the cryogenic H2 recovery unit) may have an H2 content of about 73% and may require further purification via a PSA H2 recovery unit (it could be termed an H2 purification unit) to form a third H2 stream 40c. The first H2 stream 40a could be the second H2 stream 40b (if the PSA H2 recovery unit is not applied) or the third H2 stream 40c (if the PSA H2 recovery unit is applied, as shown in this figure), as described herein.

A gaseous H2 recovery step outlet stream 20e is produced in the H2 purification unit which contains CO2 (to about ˜68%), H2 (about 8%), and N2 (about 12%), and remaining trace components. This gaseous H2 recovery step outlet stream 20e is preferably routed to the incinerator as off-gas 50 as described in the embodiment of the preceding figure.

The second recovered H2 stream 40b having an H2 content of about 73% may also be used directly as a fuel 40 (e.g. as a fuel for the incinerator). In such a case, the shown PSA H2 recovery unit may not be required.

The above embodiment has the advantage that a CO2 recovery of ˜90% can be achieved. Furthermore, a H2 recovery of about 85% can be achieved. Significant reduction in CO2 emissions are achieved, e.g. about 49% compared to traditional applications.

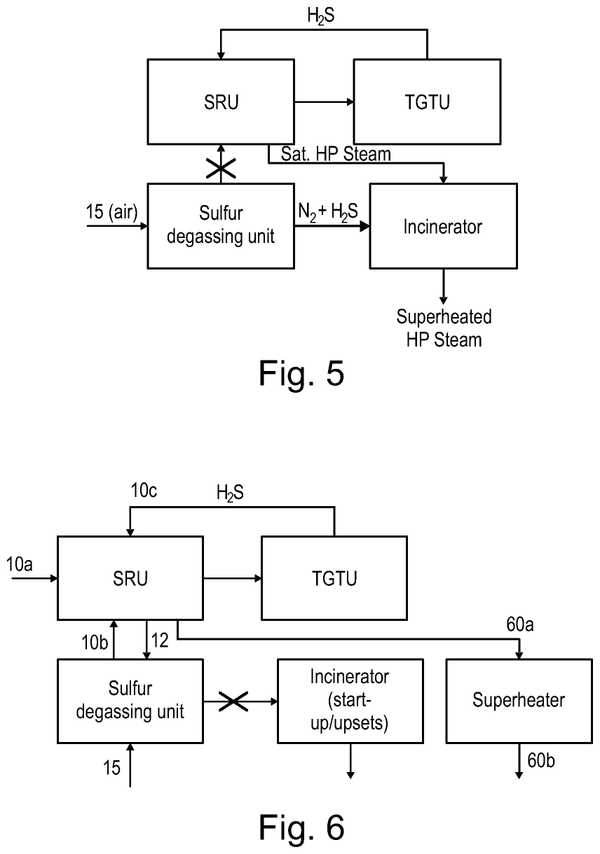

FIG. 5 is a detailed schematic view of an SRU, TGTU, sulfur degassing unit and an incinerator according to a conventional method and/or system.

A degassing step may be beneficial to remove residual gaseous H2S in a liquid phase 12 comprising sulfur. The liquid phase 12 comprising sulfur may be produced in the SRU by way of a condenser. The liquid phase 12 comprising sulfur may be collected by gravity at the bottom of the condenser. Small amounts of gaseous H2S and/or H2Sn (wherein n is an integer greater than 1) may be dissolved therein. This may be detrimental due to the release of flammable, toxic and/or corrosive H2S. Thus, the components need to be degassed, e.g. removed from the liquid phase 12.

In this conventional method, air is used as a stripping agent to degas H2S. However, air has considerable amounts of N2. Thus, routing the gaseous outlet from the sulfur degassing unit to the SRU would be detrimental for the subsequent CO2 and/or H2 recovery steps. Further, the amount of N2 would entail that the components and/or units increase in size. Accordingly, the gaseous outlet of the degassing is required to be routed to the incinerator (this is indicated by the crossed out connection line from the sulfur degassing unit to the SRU). This is detrimental as it increases an amount of fuel for the incinerator.

FIG. 6 is a detailed schematic view of an SRU, TGTU, sulfur degassing unit and an incinerator according to an embodiment of the invention.

Degassing facilitates formation of gaseous H2S from a liquid phase 12 comprising sulfur (S). In here, degassing is performed using a no air as a stripping agent 15. If air is used as the stripping agent 15, the gas formed after the degassing would need to be circulated to the incineration, rather than to the SRU, as the N2 adversely affects the CO2 and/or H2 recovery step (as shown in FIG. 5). Using CO2 as the stripping agent 15, preferably using CO2 substantially as the sole stripping agent 15, allows to circulate the formed gas after the degassing step to the SRU as the third gaseous entry stream 10c, since there is substantially no N2 in the gas compared to using air. This is indicated by the crossed out connection line from the sulfur degassing unit to the incinerator.

It is appreciated that degassing comprises using recovered CO2 as the stripping agent 15, preferably wherein at least 90%, preferably at least 94%, more preferably at least 96%, most preferably 100% of the stripping agent 15 is recovered CO2. Thus, it is advantageously made use of recovered CO2 according to the present disclosure.

The amount of gas entering the incinerator is substantially reduced according to this embodiment. The incinerator may thus primarily serve to superheat a high pressure heated steam 60a, e.g. a high pressure heated steam 60a that is formed by the SRU and that could beneficially be used for heated steam applications. The high pressure heated steam 60a should be heated up to about 400° C. (which may correspond to a minimum required temperature to use the steam for an HP steam grid). Preferably, the high pressure heated steam 60a is further heated to at least 500° C. or at least 750° C. high pressure superheated steam 60b.

Such a superheating could be done more efficiently with a specifically designed superheating unit as shown in this figure (instead of using the incinerator unit). The incinerator may merely be used during start-up or upset scenarios, e.g. when a gaseous outlet stream 20a bypasses the TGTU. The superheating unit may be designed to maximize efficiency by making full use of radiative and convective heat transfer. Superheated in the incinerator would rather be based on (merely) convective heat transfer. In addition, it may be the case that the incinerator is designed for a gaseous stream bypassing the TGTU, which could be a large amount of gaseous stream. However, the incinerator would normally be operated at a lower gaseous stream than for which it is designed for. Such an operation may not be economical for superheating purposes.

FIG. 7 is a flow chart of a method 100 of sulfur, carbon dioxide and hydrogen recovery according to an embodiment of the invention.

The method 100 comprises:
providing 110 a first gaseous entry stream and optionally a second gaseous entry stream, both comprising hydrogen sulfide (H2S) and CO2;
a sulfur recovery step 120 for recovering sulfur (S) from at least part of the H2S provided with the gaseous entry stream(s) to produce a liquid phase comprising sulfur (S),
   wherein recovering comprises a reaction of the gaseous entry stream(s) with oxygen enriched air, wherein the oxygen enriched air contains preferably at least 30%, more preferably at least 40%, more preferably at least 50%, more preferably at least 60%, more preferably at least 70%, more preferably at least 80%, more preferably at least 90%, more preferably at least 95%, most preferably at least 98.5% oxygen,
   wherein the sulfur recovery step also produces a gaseous outlet stream comprising CO2 and H2;
a CO2 recovery step 130 for recovering at least part of the CO2 provided with the gaseous outlet stream;
an H2 recovery step 140 for recovering at least part of the H2 provided with the gaseous outlet stream;
an incinerating step 150 for incinerating an off-gas derived from the gaseous outlet stream, wherein at least 50%, preferably at least 55%, more preferably at least 60%, more preferably at least 65%, more preferably at least 70%, more preferably at least 75%, more preferably at least 80%, more preferably at least 85%, more preferably at least 90%, most preferably at least 95% of an energy required for the incinerating is provided by the recovered H2.

Optionally, the method comprises:
a degassing step 160 for degassing, using a stripping agent, preferably using no ambient air as the stripping agent, at least part of residual H2S contained in the liquid phase comprising sulfur (S) to form the second gaseous entry stream comprising gaseous H2S and at least part of the stripping agent 15.
a treatment step 170 for treating the gaseous outlet stream of the sulfur recovery step 120 to produce a gas comprising H2S and a gaseous outlet stream comprising CO2 and H2, wherein the produced gas comprising H2S is used as a third gaseous entry stream in the sulfur recovery step.

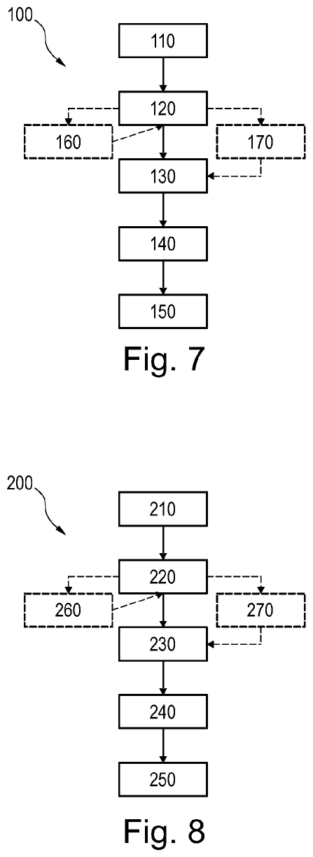

FIG. 8 is a flow chart of a system 200 of sulfur, carbon dioxide and hydrogen recovery according to an embodiment of the invention.

The system 200 comprises:
means 210 for providing a first gaseous entry stream and optionally a second gaseous entry stream, both comprising hydrogen sulfide (H2S) and CO2;
a sulfur recovery unit (SRU) 220 for recovering sulfur (S) from at least part of the H2S provided with the gaseous entry stream(s) to produce a liquid phase comprising sulfur (S),
   wherein recovering comprises a reaction of the gaseous entry stream(s) with oxygen enriched air, wherein the oxygen enriched air contains preferably at least 30%, more preferably at least 40%, more preferably at least 50%, more preferably at least 60%, more preferably at least 70%, more preferably at least 80%, more preferably at least 90%, more preferably at least 95%, most preferably at least 98.5% oxygen,
   wherein the SRU also produces a gaseous outlet stream comprising CO2 and H2;
a CO2 recovery unit 230 for recovering at least part of the CO2 provided with the gaseous outlet stream;
an H2 recovery unit 240 for recovering at least part of the H2 provided with the gaseous outlet stream;
an incinerator unit 250 for incinerating an off-gas derived from the gaseous outlet stream, wherein at least 50%, preferably at least 55%, more preferably at least 60%, more preferably at least 65%, more preferably at least 70%, more preferably at least 75%, more preferably at least 80%, more preferably at least 85%, more preferably at least 90%, most preferably at least 95% of an energy required for the incinerating is provided by the recovered H2.

Optionally, the system 200 comprises:
a degassing unit 260, for degassing, using a stripping agent, preferably using no ambient air as the stripping agent, at least part of residual H2S contained in the liquid phase comprising sulfur (S) to form the second gaseous entry stream comprising gaseous H2S and at least part of the stripping agent.
a tail gas treatment unit (TGTU) 270 for treating the gaseous outlet stream of the SRU 220 to produce a gas comprising H2S and a gaseous outlet stream comprising CO2 and H2, wherein the produced gas comprising H2S is used as a third gaseous entry stream in the SRU 220.

To illustrate the significant reduction in CO2 emission that the inventors have provided for, the following numbers are presented based on working examples.

The convention (CONV) method (see FIG. 1) yields the following CO2 emissions:

$${CONV}_{E m i s s i o n s} = 17950.43 \frac{kmol}{hr} \times 3.4183 mol \% \times 44 \frac{kg}{kmol} \times 24 \frac{hr}{d} \times \frac{tonne}{1000 kg}$$

$${CONV}_{E m i s s i o n s} = 648 \frac{tonne}{d} .$$

In the equations,

$$44 \frac{kg}{kmol}$$

corresponds to the molar weight of CO2. Furthermore, the term 3.4183 mol % follows from the amount of CO2 in the overall gas.

Applying the method and/or system according to an embodiment described herein (INV) (using H2 as fuel for the incinerator unit) leads to the following CO2 emissions:

$${INV}_{E m i s s i o n s} = 5161 \frac{kg}{h} \times 24 \frac{hr}{d} \times \frac{tonne}{1000 kg}$$

$${INV}_{E m i s s i o n s} = 124 \frac{tonne}{d} .$$

Thus, an overall emission reduction of

$$648 \frac{tonne}{d} - 124 \frac{tonne}{d} = 524 \frac{t o n n e}{d}$$

may be reached, which corresponds to 524/648˜81%.

A particular benefit attributable to the present method and/or system is the reduction of emissions due to a reduction of gas that is routed to the incinerator, an increased CO2 recovery, usage of H2 as fuel gas and an overall gas reduction as described herein.

Conventional methods with solvent based absorption process(es) have a CO2 recovery of about 90% at the sweet spot. Higher recovery numbers would be cause exponentially increasing expenses as significantly larger solvent circulation and power for operation would be required. The remaining 10% of the gas formed in the CO2 recovery unit according to conventional methods are routed to the incinerator (which is a relatively large amount). Further, the presence of N2 (originating from air) as an inert gas necessitates the addition of fuel gas to make the mixture combustible in the incinerator.

The present method and/or system can provide for a 99% CO2 recovery (PSA and/or cryogenic processes). This may be attributable to a large difference in the binding forces and/or boiling points between CO2 and H2 facilitating a relatively easy recovery. Accordingly, smaller amounts of gaseous streams (e.g. off-gas 50) are routed to the incinerator. Further, also the reduced amount of N2 contributes to a reduction of the gases routed to the incinerator. The CO2 emissions are further reduced when using the recovered H2 as fuel gas.

It will be apparent to those skilled in the art that numerous modifications and variations of the described examples and embodiments are possible in light of the above teaching. The disclosed examples and embodiments are presented for purposes of illustration only. Other alternate embodiments may include some or all of the features disclosed herein. Therefore, it is the intent to cover all such modifications and alternate embodiments as may come within the true scope of this invention.

### 6. LIST OF REFERENCE SIGNS

5 oxygen enriched air
10 gaseous entry stream(s)
10a first gaseous entry stream
10b second gaseous entry stream
10c third gaseous entry stream
12 liquid phase comprising sulfur (S)
15 stripping agent
20a gaseous outlet stream of the sulfur recovery step/unit
20b gaseous outlet stream of the treatment step/tail gas treatment unit
20c gaseous outlet stream with increased pressure
20c′ dried gaseous outlet stream with increased pressure
20d gaseous CO₂ recovery step outlet stream
20e gaseous H2 recovery step outlet stream
30 separated/recovered CO2 stream
30a separated/recovered CO2 stream with increased pressure
40 separated/recovered H2 stream
40a first separated/recovered H2 stream
40b second separated/recovered H2 stream
40c third separated/recovered H2 stream
40d fourth separated/recovered H2 stream
50 off-gas to be incinerated (derived from the gaseous outlet stream)
60 water
60a heated steam
60b superheated steam
100 method
110 providing a gaseous entry stream
120 sulfur recovery step
130 CO2 recovery step
140 H2 recovery step
150 incinerating step
160 degassing step
170 treatment step
200 system
210 means for providing a gaseous entry stream
220 sulfur recovery unit, SRU
230 CO2 recovery unit
240 H2 recovery unit
250 incinerator unit
260 (sulfur) degassing unit
270 tail gas treatment unit (TGTU)

1. A method for sulfur (S), carbon dioxide (CO2) and hydrogen (H2) recovery from a gaseous stream, the method comprising:
providing a first gaseous entry stream and optionally a second gaseous entry stream, both comprising hydrogen sulfide (H2S) and CO2;
a sulfur recovery step for recovering sulfur (S) from at least part of the H2S provided with the gaseous entry stream(s) to produce a liquid phase comprising sulfur (S),
wherein recovering comprises a reaction of the gaseous entry stream(s) with oxygen enriched air, wherein the oxygen enriched air contains preferably at least 30% oxygen,
wherein the sulfur recovery step also produces a gaseous outlet stream comprising CO2 and H2;
a CO2 recovery step for recovering at least part of the CO2 provided with the gaseous outlet stream;
an H2 recovery step for recovering at least part of the H2 provided with the gaseous outlet stream; and
an incinerating step for incinerating an off-gas derived from the gaseous outlet stream, wherein at least 50% of an energy required for the incinerating is provided by the recovered H2.

2. The method of claim 1, further comprising:
a degassing step for degassing, using a stripping agent, preferably using no ambient air as the stripping agent, at least part of residual H2S contained in the liquid phase comprising sulfur (S) to form the second gaseous entry stream comprising gaseous H2S and at least part of the stripping agent.

3. The method of claim 1, wherein at least part of the recovered CO2 is used as the stripping agent, preferably wherein at least 90% of the recovered CO2 are used as the stripping agent.

4. The method of claim 1, wherein at least part of the recovered H2 is used as fuel for incinerating the off-gas.

5. The method of claim 1, wherein 100% of the energy required for incinerating the off-gas is provided by the recovered H2.

6. The method of claim 1, wherein the CO2 recovery step comprises:
using an adsorption process, such as a pressure swing adsorption (PSA) process, a cryogenic process or an absorption process, preferably using a PSA process or a cryogenic process to separate CO2 from the gaseous outlet stream downstream the sulfur recovery step to form a recovered CO2 stream with a CO2 content of at least 94%.

7. The method of claim 1, wherein the H2 recovery step comprises:
using an adsorption process, such as a pressure swing adsorption (PSA), a cryogenic process or an absorption process, preferably using a PSA process or a cryogenic process to separate H2 from the gaseous outlet stream downstream the sulfur recovery step to form a first H2 stream with an H2 content of at least 45%.

8. The method of claim 6, wherein the H2 recovery step comprises:
using an adsorption process, such as a pressure swing adsorption (PSA), a cryogenic process or an absorption process, preferably using a PSA process or a cryogenic process to separate H2 from the gaseous outlet stream downstream the sulfur recovery step to form a first H2 stream with an H2 content of at least 45%;
wherein,
when the CO2 recovery step comprises using a cryogenic process, H2 is separated substantially simultaneously with the separation of CO2 to form a second H2 stream, followed by an optional PSA process to form a third H2 stream, wherein the third H2 stream has a higher H2 content than the second H2 stream, wherein the first H2 stream is the second H2 stream or the third H2 stream;
when the CO2 recovery step comprises using a PSA process, a PSA process is used to separate H2 from a gaseous CO₂ recovery step outlet stream formed in the CO2 recovery step to form a fourth H2 stream, wherein, optionally, the first H2 stream is the fourth H2 stream.

9. The method of claim 1, further comprising:
a treatment step for treating the gaseous outlet stream of the sulfur recovery step to produce a gas comprising H2S and a gaseous outlet stream comprising CO2 and H2, wherein the produced gas comprising H2S is used as a third gaseous entry stream in the sulfur recovery step.

10. The method of claim 6, further comprising:
a treatment step for treating the gaseous outlet stream of the sulfur recovery step to produce a gas comprising H2S and a gaseous outlet stream comprising CO2 and H2, wherein the produced gas comprising H2S is used as a third gaseous entry stream in the sulfur recovery step;
increasing the pressure of the gaseous outlet stream produced in the treatment step to form a gaseous outlet stream with increased pressure, wherein, optionally,
when the CO2 recovery step comprises using a cryogenic process, the pressure of the gaseous outlet stream produced in the treatment step is increased from a range of between 0.1 to 1.0 bar gauge (barg) to a range of between 20 to 30 barg; or
when the CO2 recovery step comprises using a PSA process, the pressure of the gaseous outlet stream-produced in the treatment step is increased from a range of between 0.1 to 1.0 bar gauge (barg) to a range of between 30 to 60 barg.

11. The method of claim 1, further comprising:
dehydrating, using a glycol, such as triethylene glycol (TEG) the recovered CO2 stream downstream the CO2 recovery step.

12. The method of claim 1, further comprising:
increasing the pressure of the recovered CO2 stream to a range of between 40 to 300 barg to form a recovered CO2 stream with increased pressure.

13. The method of claim 1, further comprising:
using at least part of the recovered CO2 stream downstream the CO2 recovery step for enhanced oil and/or gas recovery in a production field.

14. The method of claim 1, further comprising:
heating water, using the thermal energy of the sulfur recovery step, to form heated steam, preferably high pressure heated steam,
further heating the heated steam to form superheated steam, preferably high pressure superheated steam, wherein further heating is performed:
in the incinerating step, using the thermal energy of the incinerating step; preferably
in a separate step, using a superheating unit.

15. The method of claim 1, wherein the off-gas derived from the gaseous outlet stream that is incinerated is at least part of:
the gaseous outlet stream;
a gaseous CO₂ recovery step outlet stream formed in the CO2 recovery step; and/or
a gaseous H2 recovery step outlet stream formed in the H2 recovery step.

16. A system for sulfur (S), carbon dioxide (CO2) and hydrogen (H2) recovery from a gaseous stream comprising hydrogen sulfide (H2S) and CO2, the system comprising means for carrying out the method of claim 1.

17. The system according to claim 16, further comprising:
means for providing a first gaseous entry stream and optionally a second gaseous entry stream, both comprising hydrogen sulfide (H2S) and CO2;
a sulfur recovery unit (SRU) for recovering sulfur (S) from at least part of the H2S provided with the gaseous entry stream(s) to produce a liquid phase comprising sulfur (S),
wherein recovering comprises a reaction of the gaseous entry stream(s) with oxygen enriched air, wherein the oxygen enriched air contains preferably at least 30% oxygen,
wherein the SRU also produces a gaseous outlet stream comprising CO2 and H2;
a CO2 recovery unit for recovering at least part of the CO2 provided with the gaseous outlet stream;
an H2 recovery unit for recovering at least part of the H2 provided with the gaseous outlet stream;
an incinerator unit for incinerating an off-gas derived from the gaseous outlet stream, wherein at least 50% of an energy required for the incinerating is provided by the recovered H2.

18. The system according to claim 16, further comprising:
a degassing unit for degassing, using a stripping agent, preferably using no ambient air as the stripping agent, at least part of residual H2S contained in the liquid phase comprising sulfur (S) to form the second gaseous entry stream comprising gaseous H2S and at least part of the stripping agent.

19. The system according to claim 16, wherein the CO2 recovery unit comprises:
a cryogenic unit having a molecular sieve unit for dehydration of the gaseous outlet stream, a refrigeration unit for cooling the gaseous outlet stream and a cryogenic purification unit for separating CO2 from the gaseous outlet stream downstream the SRU; or
a pressure swing adsorption (PSA) unit comprising one or more adsorption beds for separating a CO2 from the gaseous outlet stream downstream the SRU;
wherein the CO2 recovery unit is configured to form a recovered CO2 stream with a CO2 content of at least 94%.

20. The system according to claim 16, wherein the H2 recovery unit is part of the CO2 recovery unit and/or wherein the H2 recovery unit comprises:
a pressure swing adsorption (PSA) unit comprising one or more adsorption beds for separating H2 from the gaseous outlet stream downstream the sulfur recovery step;
wherein the H2 recovery unit is configured to form a first, second, third and/or fourth H2 stream with an H2 content of at least 45%.

21. The system according to claim 16, further comprising:
a tail gas treatment unit (TGTU) for treating the gaseous outlet stream of the SRU to produce a gas comprising H2S and a gaseous outlet stream comprising CO2 and H2, wherein the produced gas comprising H2S is used as a third gaseous entry stream in the SRU.

22. The system according to claim 16, further comprising:
a low pressure (LP) compressor arranged between the SRU and the CO2 recovery unit for increasing the pressure of the gaseous outlet stream produced in the TGTU to form a gaseous outlet stream with increased pressure,
wherein the LP compressor is preferably configured:
to increase the pressure from a range of between 0.1 to 1.0 bar gauge (barg) to a range of between 20 to 30 barg; or
to increase the pressure from a range of between 0.1 to 1.0 bar gauge (barg) to a range of between 30 to 60 barg.

23. The system according to claim 16, further comprising:
a dehydration unit, preferably a glycol, such as triethylene glycol (TEG) dehydration unit for dehydrating the recovered CO2 stream downstream the CO2 recovery unit.

24. The system according to claim 16, further comprising:
one or more high pressure (HP) compressor(s) downstream the CO2 recovery unit for increasing the pressure of the recovered CO2 stream to a range of between 40 to 300 barg to form a recovered CO2 stream with increased pressure.

25. The system according to claim 16, wherein the SRU is configured to heat water, using the thermal energy of the SRU, to form heated steam, preferably high pressure heated steam.

26. The system according to claim 16, wherein the incinerator unit is configured to further heat the heated steam, using the thermal energy of the incinerator unit, to form superheated steam, preferably high pressure superheated steam.

27. The system according to claim 25, further comprising:
a superheating unit to further heat the heated steam to form superheated steam, preferably high pressure superheated steam.

28. A computer program comprising instructions which, when the program is executed by a computer, cause the computer to control and/or to carry out the method of claim 1.
